(19) United States
(12) Patent Application Publication
(10) Pub. No.: US 2012/0026191 A1
(43) Pub. Date: Feb. 2, 2012

(54) METHOD FOR DISPLAYING AUGMENTATION INFORMATION IN AN AUGMENTED REALITY SYSTEM

(75) Inventors: Par-Anders Aronsson, Malmo (SE); Erik Backlund, Uddevalla (SE); Andreas Kristensson, Sodra Sandby (SE)

(73) Assignee: SONY ERICSSON MOBILE COMMUNICATIONS AB, Lund (SE)

(21) Appl. No.: 13/143,132

(22) PCT Filed: Jul. 5, 2010
(86) PCT No.: PCT/EP2010/004055

§ 371 Date: Jul. 1, 2011

(51) Int. Cl. G09G 5/00

(52) U.S. Cl. 345/633

(57) ABSTRACT

A method for displaying augmentation information in an augmented reality system (100) is provided. According to the method a reality information is detected with an imaging device (102) and a human face (200) is automatically detected in the reality information. Depending on the detected human face (200) a predetermined mapping is automatically assigned to the reality information. The mapping comprises a plurality of mapping areas (1-17) in which augmentation information can be displayed.

The present invention relates to a method for displaying augmentation information in an augmented reality system and to an augmented reality system.

### BACKGROUND OF THE INVENTION

In augmented reality systems a view of a physical real-world environment is augmented by virtual computer-generated information. The view of the physical real-world environment may be a direct or indirect live view displayed on eyeglasses, lenses or other display means to a user of the augmented reality system. When the user of the augmented reality system is standing or talking face-to-face with another person augmentation information may be displayed. However, when the amount of the displayed augmentation information is increasing, the user of the augmented reality system may be distracted from the conversation with the other person.

Therefore, there is a need for an appropriate displaying of augmentation information in an augmented reality system.

### SUMMARY OF THE INVENTION

According to the present invention, this object is achieved by a method for displaying augmentation information in an augmented reality system as defined in claim 1 and an augmented reality system as defined in claim 11. The dependent claims define preferred and advantageous embodiments of the invention.

According to an aspect of the present invention, a method for displaying augmentation information in an augmented reality system is provided. According to the method, a reality information is detected with an imaging device. The reality information comprises an image of an environment of the imaging device. Furthermore, a human face is automatically detected in the reality information and a predetermined mapping is automatically assigned to the reality information depending on the detected human face. The predetermined mapping comprises a plurality of mapping areas which are each configured to display augmentation information. Finally, the augmentation information is displayed in a predetermined mapping area of the plurality of mapping areas.

By automatically detecting the human face in the reality information and displaying the augmentation information in predetermined mapping areas of the predetermined mapping, the augmentation information can be displayed in appropriate locations in relation to the detected human face and therefore the human face is not concealed in an unwanted way by the augmentation information. For example, the augmentation information may be automatically displayed in mapping areas located outside of the eyes or the mouth of the human face. Thus, the face-to-face view is not obstructed by the augmentation information. Furthermore, if a very important or urgent augmentation information shall be displayed, this augmentation information can be displayed in mapping areas where the user of the augmented reality system recognizes these information immediately, for example in mapping areas located at the eyes, the nose or the mouth of the detected human face.

According to an embodiment, the predetermined mapping comprises a default mapping comprising a plurality of mapping areas which are assigned to areas of the human face. The mapping areas may comprise for example an area on the left forehead, an area on the right forehead, an area covering an eye of the human face, an area covering the nose of the human face, areas covering the cheeks of the human face or areas covering parts of the chin of the detected human face. Furthermore, the predetermined mapping may comprise a default mapping comprising a plurality of mapping areas assigned to areas adjacent to the human face, for example mapping areas left or right beside the forehead of the human face or mapping areas left or right beside the cheeks of the human face. This allows the augmentation information to be arranged in a lot of appropriate and convenient mapping areas.

According to another embodiment, a person is automatically recognized from a plurality of persons based on the human face comprised in the reality information. Furthermore, a plurality of mappings are provided and each of the mappings is respectively assigned to one person of the plurality of persons. Depending on the recognized person the mapping assigned to the recognized person is automatically assigned to the reality information. Therefore, depending on the recognized person, a person-specific mapping can be used to display the augmentation information in connection with the recognized person in the reality information.

According to another embodiment, the augmentation information comprises information about the recognized person. The information about the recognized person may comprise for example the name of the person, the birthday of the person, information about appointments with the person or any other information related to the person.

According to another embodiment, the mapping is configurable by a user of the augmented reality system. Furthermore, the kind of augmentation information to be displayed may also be configurable by the user of the augmented reality system and the mapping area where the augmentation information is to be displayed may also be configurable by the user of the augmented reality system. This allows the user of the augmented reality system to individually configure the whole arrangement of the augmentation information in connection with the human face of the reality information.

In addition to the above-described kinds of augmentation information, the augmentation information may comprise for example an e-mail information indicating for example the arrival of a new e-mail, a calendar information indicating for example a list of appointments of the current day, an appointment information indicating for example the time and date information of a next appointment, and a time of the day information. This allows the user of the augmented reality system to be informed about important and actual information while the user is having a conversation with the person whose face is present in the reality information.

Furthermore, the augmentation information may comprise visual control information or virtual control elements indicating an actuation of a function of the augmented reality system. The function of the augmented reality system may comprise for example starting and stopping an audio and video recording of the reality information or an opening of an incoming e-mail or an upcoming appointment. For actuating the function of the augmented reality system the eyes of the user of the augmented reality system are automatically tracked and it is automatically detected if the user is looking at the optical control information. Upon detecting that the user is looking at the optical control information or that the user is looking in a predetermined sequence at several items of the optical control information the function of the augmented reality system is automatically actuated. This allows the user of the augmented reality system to actuate specific functions of the augmented reality system without using a manual control device. Thus, the function of the augmented reality system can be actuated without being noticed by the person being in front of the user of the augmented reality system. The optical control information may be displayed as the augmentation information in one of the mapping areas. When the optical control information is arranged for example in a mapping area covering the forehead of the human face in the reality information, the function of the augmented reality system represented by the optical control information can be actuated by the user while still looking at the human face in the reality information.

According to another aspect of the present invention, an augmented reality system is provided. The system comprises an imaging device for detecting reality information, a display unit adapted to display augmentation information in combination with the reality information, and a processing unit coupled to the imaging device and the display unit. The imaging device may comprise for example a camera for capturing an image of an environment of the camera as the reality information. The processing unit is adapted to detect a human face in the reality information and to assign a predetermined mapping to the reality information depending on the detected human face. The mapping comprises a plurality of mapping areas and the processing unit is adapted to display the augmentation information in a predetermined mapping area of the plurality of mapping areas. The augmented reality system may be adapted to perform the above-described method and comprises therefore the above-described advantages.

The display unit may comprise eyeglasses adapted to display the reality information in connection with the augmentation information. The eyeglasses may be adapted to pass through the reality information transparently to a user of the eyeglasses and present via an electronic display of the eyeglasses the augmentation information simultaneously and synchronized with the reality information to the user. This offers the user a convenient way to receive the augmentation information while the user is face to face to a person.

According to another embodiment, the display unit is adapted to display the reality information and the augmentation information simultaneously on a display. This allows a user for example during a video conference to receive the augmentation information while looking at another person of the video conference.

The augmented reality system, especially the processing unit, may be included in a mobile device, for example a mobile phone, a person digital assistant, a mobile navigation system, or a mobile computer.

Although specific features described in the above summary and the following detailed description are described in connection with specific embodiments, it is to be understood that the features of the embodiments can be combined with each other unless noted otherwise.

### BRIEF DESCRIPTION OF THE DRAWINGS

The invention will now be described in more detail with reference to the accompanying drawings.

FIG. 1 shows a schematic diagram of an augmented reality system according to an embodiment of the present invention.

FIG. 2 shows schematically a reality information detected by an imaging device of an augmented reality system.

FIG. 3 shows a mapping assigned to the reality information of FIG. 2 according to an embodiment of the present invention.

FIG. 4 shows augmentation information displayed in mapping areas of the mapping of FIG. 3.

FIG. 5 shows further augmentation information displayed in the mapping areas of the mapping of FIG. 3.

### DETAILED DESCRIPTION OF PREFERRED EMBODIMENTS

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise. Same reference signs in the various instances of the drawings refer to similar or identical components.

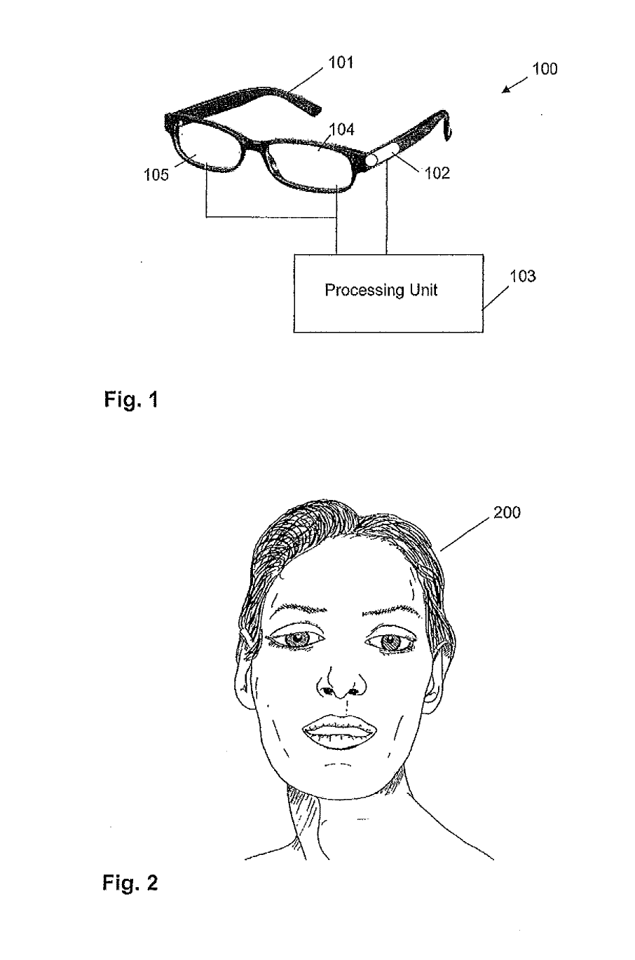

FIG. 1 shows an augmented reality system 100. The augmented reality system 100 comprises eyeglasses 101, a camera 102 mounted at a frame of the eyeglasses 101, and a processing unit 103. The eyeglasses 101 comprise two eye glass lenses 104, 105 which are adapted to pass through light from an environment in front of the eyeglasses 101 to eyes of a user wearing the eyeglasses 101, and at the same time to display augmentation information which is generated by the processing unit 103 to the user by overlaying the augmentation information over the reality information of the environment. Therefore, the eye glass lenses 104, 105 are coupled as shown in FIG. 1 to the processing unit 103. The camera 102 attached to the frame of the eyeglasses 101 is also coupled to the processing unit 103 and adapted to capture the reality information comprising an image of the environment in front of the eyeglasses 101. The processing unit 103 may be integrated into the frame of the eyeglasses 101 or may be integrated in a mobile device the user of the eyeglasses 101 is carrying and may be coupled to the eyeglasses 101 via a wire or a wireless connection.

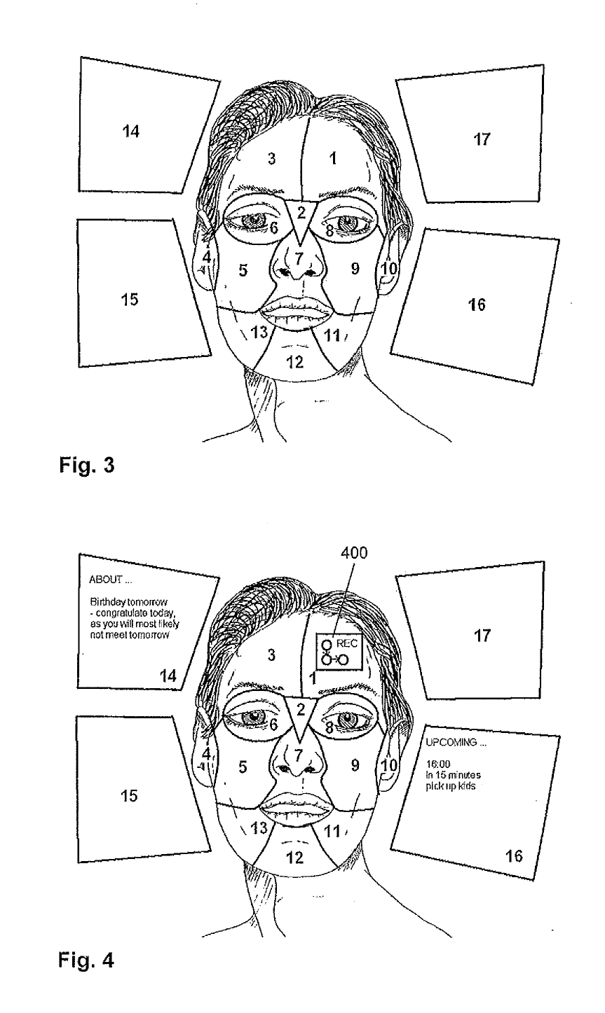

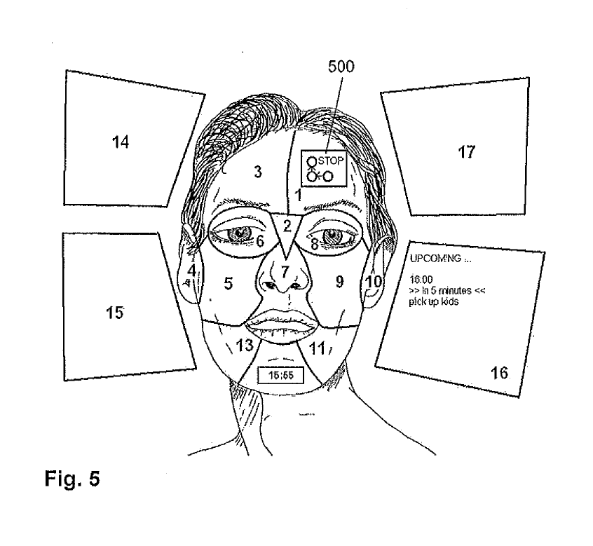

In operation the processing unit 103 receives the reality information captured by the camera 102 and detects if a human face is present in the reality information. FIG. 2 shows an example of a human face 200 detected in the reality information. Upon detection of the human face 200 in front of the eyeglasses 101 and thus in front of the user wearing the eyeglasses 101, the processing unit 103 divides the face 200 into a plurality of mapping areas by use of a face-mapping technology. FIG. 3 shows an exemplary mapping applied to the human face 200 of FIG. 2. In this example, the human face 200 is split into thirteen mapping areas 1-13. Mapping areas 1 and 3 are assigned to the left and right forehead, respectively. Mapping area 2 is assigned to an upper part of the nose and mapping area 7 is assigned to a lower part of the nose and the mouth. Mapping areas 6 and 8 are assigned to the right eye and left eye, respectively, and mapping areas 4 and 10 are assigned to the right ear and the left ear, respectively. Mapping areas 5 and 9 are assigned to the right cheek and left cheek of the human face 200 and mapping areas 11, 12 and 13 are assigned to a left part of the chin, a middle part of the chin and a right part of the chin, respectively. It should be noted that the split lines and the reference signs in FIG. 3 are only shown for descriptive needs and may not be displayed to a user of the augmented reality system 100. Furthermore, as shown in FIG. 3, additional mapping areas 14-17 are arranged beside the human face. As stated above, the delimiting lines and the reference signs of the mapping areas 14-17 are not displayed to the user of the augmented reality system and are shown in the FIG. 3 for descriptive needs only. The mapping areas 1-17 defined in FIG. 3 are used as display areas for augmentation information as will be described in more detail in connection with FIGS. 4 and 5. The assignment which augmentation information is displayed in which mapping area may be predetermined or may be configurable by the user of the augmented reality system. For example, when a new face is detected, a predetermined mapping and assignment of augmentation information to the mapping areas may be used and may be reconfigured by the user of the augmented reality system. The reconfigured assignment may be stored in the processing unit 103. The next time this human face is recognized by the processing unit 103, the processing unit 103 uses the reconfigured assignment stored in connection with the human face.

FIG. 4 shows an exemplary assignment of augmentation information to mapping areas. In mapping area 14 an “about information” about a person whose face is detected in the reality information is displayed. This “about information” may comprise for example the name of the person, a birthday date of the person, a date information when the person was last met or any kind of specific information related to the person, for example as displayed in FIG. 4, that the person's birthday is tomorrow but, as the user of the augmented reality system will probably not meet the person tomorrow, it is recommended to congratulate today. The information about the person may be fetched from a data base provided in the processing unit 103 or may be retrieved from automatic web searches, facebook lookups and so on based for example on a face recognition technology.

In mapping area 1 a visual control information, a so-called sensorial recording control, for starting and stopping recording of audio and video data from the conversation with the person is located. To activate or de-active the recording, the eyes of the user of the augmented reality system are tracked for example by an additional camera (not shown) mounted at the eyeglasses 101 tracking the eyes of the user. For activating the recording the user has to briefly look at the three dots shown in mapping area 1 in a predetermined order. The user has to look first at the upper dot then move the look down to the lower left dot and then move the look to the lower right dot as indicated by the arrows connecting the dots. In response to this eye movement the recording will start and indicated by displaying “REC” in mapping area 1. Video and audio information from the conversation will then be recorded by the processing unit 103.

Finally, information about upcoming events are displayed in mapping area 16. The upcoming events may be retrieved from a data base of the processing unit 103 comprising calendar information of the user using the augmented reality system. Furthermore, upcoming events may comprise for example incoming phone calls or incoming e-mails. An exemplary upcoming event from a calendar is shown in FIG. 4 indicating that in fifteen minutes at 16:00 o'clock the kids have to be picked up. Thus, the user of the augmented reality system can be reminded of picking up the kids.

FIG. 5 shows the situation of FIG. 4 ten minutes later. The calendar entry to pick up the kids in area 16 is now getting more urgent, as there are now only five minutes left. Therefore, in mapping area 16 the upcoming event information is displayed indicating that the kids have to picked up in five minutes. Additionally, in mapping area 12 which is located on the chin of the human face a current time information is displayed. As the current time information is displayed in a mapping area on the human face and not beside the human face, the attention of the user of the augmented reality system is drawn to the current time information and reminds the user to check for the upcoming events in mapping area 16. For even more important information, for example in incoming phone call, this information may be displayed for example in mapping area 2 or 7. In mapping area 1 the sensorial recording control is displayed for stopping the audio and video recording. To stop the audio and video recording the user of the augmented reality system has to take a look at the three dots in the order indicated by the arrows.

As described above, the augmented reality system 100 allows the user of the augmented reality system 100 to receive augmentation information while having a conversation with a person in front of the user. As the displayed augmentation information is configurable by the user, only that kind of information is displayed during the conversation which is appropriate in the user's view. Therefore, the user is not distracted unnecessarily from the conversation by the augmentation information.

While exemplary embodiments have been described above, various modifications may be implemented in other embodiments. For example, the predetermined mapping as shown in FIG. 3 may also be configurable by the user of the augmented reality system and may also be stored in connection with a recognized human face in the processing unit 103 to be re-used when the human face is recognized the next time. Defining the mapping and assigning augmentation information to mapping areas of the mapping may be accomplished by the user of the augmented reality system offline at a personal computer or a mobile computer or any other kind of mobile device, or may be accomplished by any other technology, for example via a brain computer interface during a conversation with the person or by sensorial controls which are actuated by an eye tracking mechanism tracking the eye movements of the user. Furthermore, the augmented reality system 100 may be realized in any other suitable manner, for example as a mobile device having a camera for capturing the reality information and a display for displaying the reality information with the overlaid augmentation information.

Finally, it is to be understood that all the embodiments described above are considered to be comprised by the present invention as it is defined by the appended claims.

1-14. (canceled)

15. A method for displaying augmentation information in an augmented reality system, the method comprising:
detecting reality information with an imaging device, the reality information comprising an image of an environment of the imaging device,
automatically detecting a human face in the reality information,
automatically assigning a predetermined mapping to the reality information depending on the detected human face, the mapping comprising a plurality of mapping areas configured to display augmentation information, and
displaying the augmentation information in a predetermined mapping area of the plurality of mapping areas.

16. The method according to claim 15, wherein the predetermined mapping comprises a default mapping comprising a plurality of mapping areas assigned to areas of the human face.

17. The method according to claim 15, wherein the predetermined mapping comprises a default mapping comprising a plurality of mapping areas assigned to areas adjacent to the human face.

18. The method according to claim 15, comprising:
automatically recognizing a person from a plurality of persons based on the human face comprised in the reality information,
providing a plurality of mappings, each of the mappings being respectively assigned to one person of the plurality of persons, and
automatically assigning the mapping assigned to the recognized person to the reality information.

19. The method according to claim 18, wherein the augmentation information comprises information about the recognized person.

20. The method according to claim 15, wherein the mapping is configurable by a user of the augmented reality system.

21. The method according to claim 15, wherein the augmentation information is configurable by a user of the augmented reality system.

22. The method according to claim 15, wherein the mapping area where the augmentation information is displayed is configurable by a user of the augmented reality system.

23. The method according to claim 15, wherein the augmentation information comprises at least one information of the group comprising Email information, calendar information, appointment information, and time of the day information.

24. The method according to claim 15, wherein the augmentation information comprises visual control information, the visual control information indicating an actuation of a function of the augmented reality system, wherein the method comprises:
automatically tracking the eyes of a user of the augmented reality system,
automatically detecting if the user is looking at the visual control information, and
automatically actuating the function of the augmented reality system upon detecting that the user is looking at the visual control information.

25. An augmented reality system, comprising:
an imaging device for detecting reality information, the reality information comprising an image of an environment of the imaging device,
a display unit adapted to display augmentation information in combination with the reality information, and
a processing unit coupled to the imaging device and the display unit, wherein the processing unit is adapted to detect a human face in the reality information, assign a predetermined mapping to the reality information depending on the detected human face, the mapping comprising a plurality of mapping areas, and display the augmentation information in a predetermined mapping area of the plurality of mapping areas.

26. The augmented reality system according to claim 25, wherein the display unit comprises eyeglasses adapted display the reality information overlaid with the augmentation information.

27. The augmented reality system according to claim 25, wherein the display unit is adapted to display the reality information and the augmentation information simultaneously.

28. The augmented reality system according to claim 25, wherein the processing unit is adapted to automatically recognize a person from a plurality of persons based on the human face comprised in the reality information and assign the predetermined mapping assigned to the recognized person to the reality information.

29. The augmented reality system according to claim 28, wherein the augmentation information comprises information about the recognized person.

30. The augmented reality system according to claim 25, wherein the augmentation information comprises visual control information indicating an actuation of a function of the augmented reality system.

31. The augmented reality system according to claim 30, wherein the system is adapted to automatically track the eyes of a user of the system, detect if the user is looking at visual control information and actuate the function of the system upon detecting that the user is looking at the visual control information.

32. The augmented reality system according to claim 25, wherein the mapping is configurable by a user of the augmented reality system.

33. The augmented reality system according to claim 25, wherein the augmentation information is configurable by a user of the augmented reality system.

34. The augmented reality system according to claim 25, wherein the mapping area where the augmentation information is displayed is configurable by a user of the augmented reality system.

35. The augmented reality system according to claim 25, wherein the augmentation information comprises at least one information of the group comprising Email information, calendar information, appointment information, and time of the day information.
